(19) United States
(12) Patent Application Publication
(10) Pub. No.: US 2008/0004980 A1
(43) Pub. Date: Jan. 3, 2008

(54) System and method for regulating supplier acceptance of service requests

(75) Inventor: Richard Hernandez, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc.

(21) Appl. No.: 11/479,603

(22) Filed: Jun. 30, 2006

(51) Int. Cl. G06Q 30/00

(52) U.S. Cl. 705/26

(57) ABSTRACT

A system and method for regulating supplier acceptance of service requests. In one embodiment, in response to receiving a request for a service of a first service provider, determining if servicing the request will exceed an identified capacity of the first service provider; and in response to determining servicing the requested service will exceed the identified capacity of the first service provider, offering to a requester of the service, an alternative.

### BACKGROUND OF THE INVENTION

In the business area of qualifying suppliers of goods and services, methods and systems are known in current art that allow customers of a supplier service to invite suppliers to join a network of suppliers, and that also allow the supplier to add himself to the network through a self-service mechanism, and further, that allow the supplier to start collaborating and transacting with participants on the network once the supplier has been certified.

The currently known invitation process allows a company who is a customer of a supplier service, such as Rearden Commerce, or Rearden Commerce itself, to use the supplier portal service to send an email or other type of communication (letter, phone call, etc.) to indicate to the supplier that someone wishes them to join the network and begin transacting. The invitation may contain a custom message and other information provided by the supplier service and the inviter.

The supplier representative may be able to click on something in the email invitation that takes him to a web page hosted by the supplier service, where he can fill out an electronic application to join the network. This application may contain information about Service Level Agreements (SLAs), transaction types, transaction methods, billing process, technical integration agreements, etc.

What is clearly needed is a system and method for an enhanced, automated qualifying process that can do an automated or partially automated evaluation of the supplier and provide different levels of certification as a result; and further, a system and method that can then supply a collaboration toolkit for the supplier to interact in an automated way with the supplier service and its customers. Furthermore, support functions in the portal may be used to simplify or automate interactions, in particular with small, independent contractors that do not have a large in-house Information Technology department.

Furthermore, in a supplier network, multiple third-party vendors provide various services. In a case of automated network, it is easy for a supplier to accept too many requests, beyond his capacity or inventory. Many small suppliers don't have a system for capacity and/or inventory management.

What is further clearly needed is a system and method for an electronic services network with an integrated inventory management system for small vendors to manage their supplies. What is further needed, in some cases, is for such a management system to have the ability to learn from past experiences and patterns how to adjust expected capacity levels.

### SUMMARY OF THE INVENTION

One embodiment as described herein provides a system and method for regulating supplier acceptance of service requests. In one embodiment, in response to receiving a request for a service of a first service provider, determining if servicing the request will exceed an identified capacity of the first service provider; and in response to determining servicing the requested service will exceed the identified capacity of the first service provider, offering to a requester of the service, an alternative.

### BRIEF DESCRIPTION OF THE DRAWINGS

FIG. 1 shows an exemplary overview 100 of a service supplier Platform SSP, in accordance with one embodiment;

FIG. 2 shows an exemplary flow 200 of the process of qualifying a new service supplier in accordance with one embodiment;

FIG. 3 shows an example of the user interface window 300 on a computer display screen of the software instance that allows a service supplier to chose his working mode, in accordance with one embodiment;

FIG. 4 shows an overview of a system 400 according to one embodiment;

FIG. 5 shows the schematic of an exemplary booking; and

FIG. 6 shows the process flow of a request, in accordance with one embodiment.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

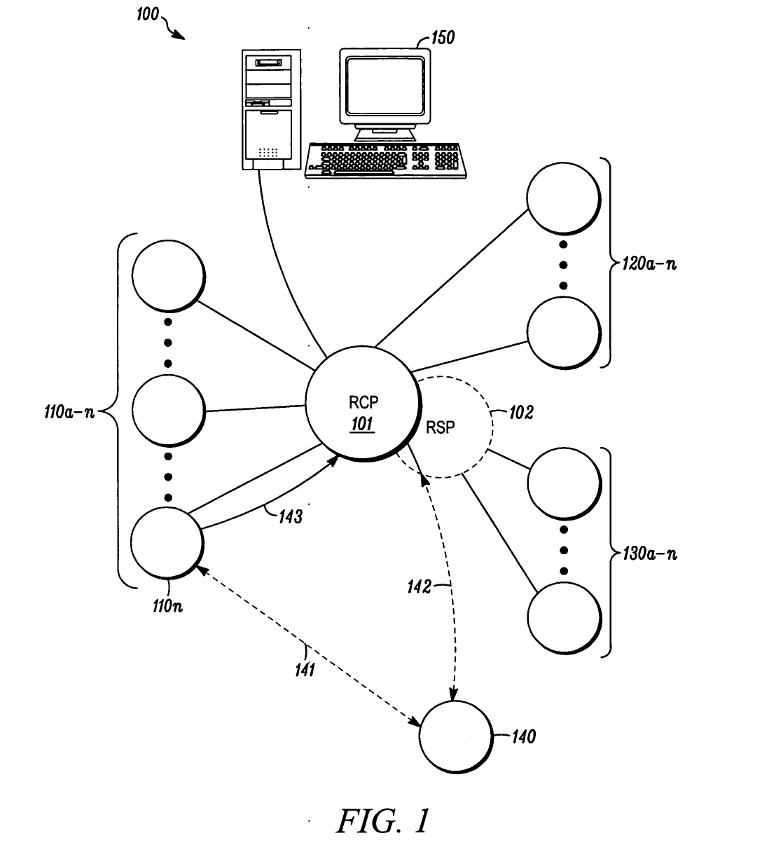

FIG. 1 shows an exemplary overview 100 of a Rearden Commerce Platform RCP 101, otherwise referenced herein as service supplier, service supplier portal, and service supplier platform. Customers 110a-n are connected to RCP 101. Also shown is Rearden Supplier Model RSP 102 that is the primary point of connection for suppliers. In this example several suppliers are shown, namely suppliers 23-120a-n, which connect directly to RCP 101 without the portal RSP 23-102 (for example, legacy suppliers, large corporate suppliers, etc.), and a second group of suppliers 130a-n, which in this example connect to RSP 102. Also shown is a new supplier 140. He was invited by customer 110n, who sent an invitation request 143 to the RCP 101. In some cases, an automatic approval of the invitation request may be issued, or in other cases, the request may be reviewed by an agent using a workstation such as 150 to review invitation requests. More detailed examples follow below. The invitation 142 is then extended to supplier, who can then use the portal to register and become activated, as further described below.

As an example of the invitation and certification process, if a supplier is invited by a customer of the service supplier, but the service supplier does not see fit to open up the supplier to broader access to the service supplier customer base, then the supplier can be certified to transact with just that one customer until they make needed improvements to their processes, technology, financial condition or other aspects of their business. Once the supplier makes necessary changes, they can re-apply for broader certification. Certification requests can be limited to n number within a time period or n days between certification requests.

Once the supplier registers itself into the network, tools would be provided to the supplier. The collaboration toolkit would provide a way for the supplier to interact in an automated way with the service supplier and its customers for setting up meetings, viewing each other's calendars, sending emails, accessing private and public address books and collaborating on the setup process for the customer-service supplier-supplier connection.

Another tool would be a set of SBL documents and a supplier portal that allows transactions to flow from customer through the service supplier to supplier and back. These SBL documents are covered in a separate patent application, but the general idea is that they are a predefined set of XML documents used as a communication mechanism for transactions. These documents contain a general wrapper for service transactions but can be customized for each industry, application or document type.

The transactional part of the supplier portal would allow the supplier to interact with the service supplier in a fully automated or partially automated manner. For example, a partially automated process would include a structured email that is sent to the supplier each time a customer wants to make a reservation request. The supplier is given n minutes to respond to the request before it is rescinded. If the supplier wishes, he can set auto-respond rules in his transaction portal that allow him to accept or decline, or request more information for these transactions.

Mapping of transaction data between customers and suppliers can be done in an easier manner through the service supplier. A best-match algorithm would allow a best-guess approximation of a mapping for all fields in an application document. For example, the set of temporary worker job titles varies widely among corporate customers and suppliers of temporary workers. There is no standard, agreed-upon taxonomy for this mapping. Therefore, a best-match algorithm that is based on such things as natural language parsing, a pre-built standard taxonomy and other technologies would reduce the amount of time needed to do this mapping.

All suppliers that are in the service supplier platform would plug into a generalized reporting and data analytics engine that would allow end users to see how the supplier has been performing. For example, a user may query the engine, “What was the average response time?” This function can be provided anonymously using aggregate data collected across customers the service supplier Platform will also monitor the service levels—the amount of time required to process a request—for the providers to ensure that they meet the agreed upon Service Level Agreements (SLAs). The supplier can sign up for automated alerts from the system when their Service Levels drop to configured thresholds.

Customers could rate the suppliers based on their interaction and these reviews would be available to the end customer before they select a supplier.

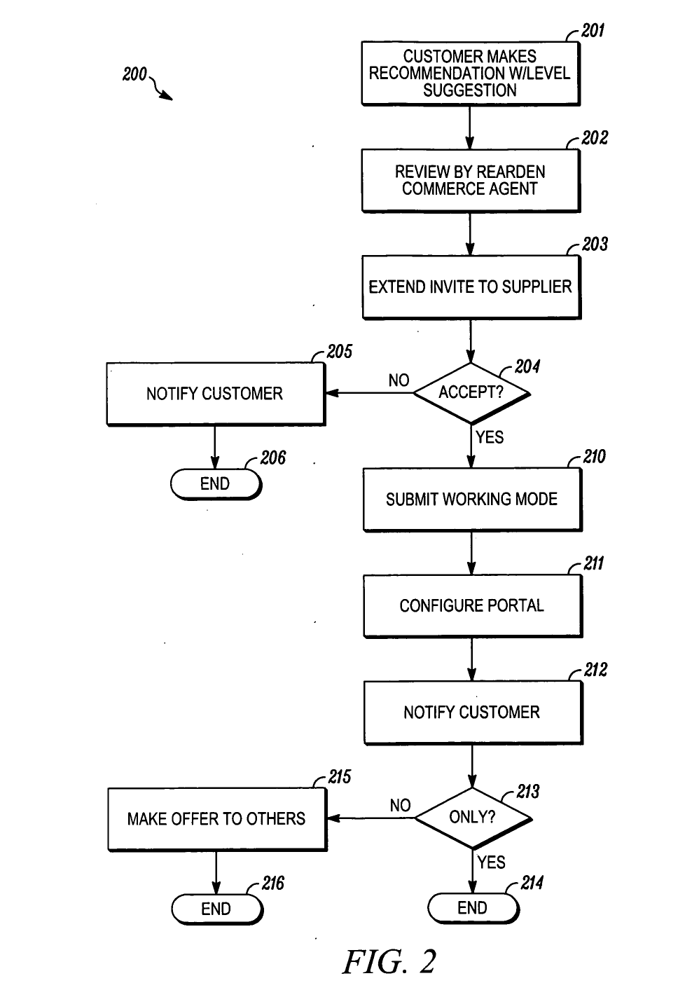

FIG. 2 shows an exemplary flow 200 of the process of qualifying a service provider of goods and services according to the novel art of this disclosure. In step 201, a customer of a service supplier recommends a service provider for acceptance in the service supplier network. The customer, in the recommendation, specifies in which of a variety of levels of certification he feels the service provider should be placed. In step 202, an agent of the service network, using an automated or partially automated evaluation process, reviews the qualifications of the recommended service provider and recommends some level of certification as a result. For example, if a service provider is invited by a customer of the network, but the network does not see fit to open up the supplier to broader access to its customer base, then the service provider can be certified to transact with just that one customer until they make needed improvements to their processes, technology, financial condition or other aspects of their business. Once the service provider makes necessary changes, they can re-apply for broader certification. In some cases, certification requests can be limited to, for example, a specific number n within a time period or n days between certification requests.

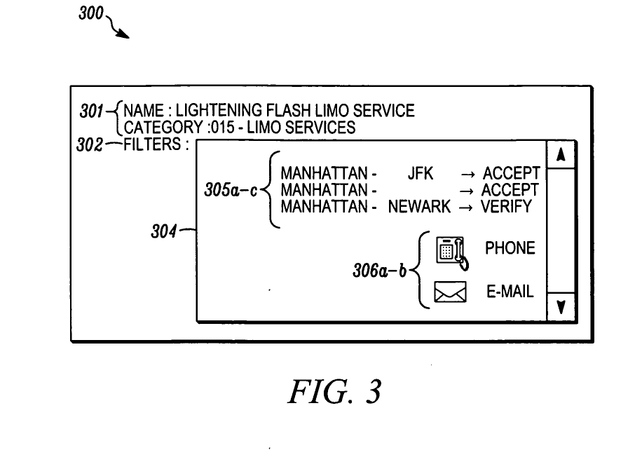

In step 203, an invitation is extended to the service provider to apply for certification in the network, and in step 204, the process branches, depending on whether the service provider accepts or declines the invitation. If the service provider declines the invitation, then in step 205, the recommending customer is notified, and in step 206, the process terminates. If the service provider accepts the invitation, then in step 210, the service provider specifies a working mode, such as automatic acceptance, require notification, manual decision, etc. See the description of element 302 in FIG. 3 for more information about this function. In step 211, the service provider registers itself into the network and receives a collaboration toolkit that would provide a way for the service provider to interact in an automated way with the network and its customers for setting up meetings, viewing each other's calendars, sending emails, accessing private and public address books and collaborating on the setup process for the customer-network-supplier connection. [should this step or another step also discuss how the supplier will not only collaborate, but also how they will interact with the system for completing services transactions?]In step 212, the recommending customer is notified of the service provider's acceptance into the network, and at step 213, the process branches, depending on whether the service provider is certified to provide goods and services to all customers in the network, or only to the recommending customer. If the service provider is certified for only the recommending customer (Yes), the process terminates at step 214. If the service provider is certified for all network customers, the process moves to step 215, where the goods and/or services of this supplier are offered to other network customers, and then to step 216, where the process terminates.

FIG. 3 shows an example of the user interface window 300 on a computer display screen of the software instance that allows a service provider to chose his working mode, as described earlier in FIG. 2, step 210. Window area 301 displays the identification, which in this example is the name and category, of the supplier. Window area 302 is an area that contains tools to parameterize and customize the portal functionality to the needs and requirements of a supplier. In this example a filter approach is shown, using information box 304, which contains the filters for the provider; in this example, the provider is a limousine service, and box 304 contains items 305a-c, comprising, in this example, two service areas in which customers are accepted (Manhattan-JFK airport and Manhattan itself and one service area (Manhattan-Newark, N.J.) that requires verification of a service order via items 23-3-6a-b, in this example, phone and/or email verification.

For example, a limo provider could have a rule set in the service supplier transaction portal that allows him to auto-accept all limo reservations within Manhattan, but alert him when transactions come through for New Jersey so he can decide manually. This could be done by sending him an e-mail or text message (aka SMSmessage), to which he could reply a “yes”, “no” or for example an acceptance password etc. In other cases, the system could launch a voice call, allowing the provider to answer a “yes” or “no” or password in a voice system, further reducing potential problems, as sending e-mail while driving is not just dangerous, but may be illegal in many places. The rules mentioned above could be used to set pricing terms, geographic and time of day terms etc. In another example, a catering company could set a rule that auto-adds a $20 surcharge for all orders placed for delivery before 7 am.

The system would, on the request of the service provider, analyze past transactions that the supplier has approved/declined to build a predictive model, perhaps build on a decision tree or clustering or similar technologies, and make a recommendation to the supplier to embed as automatic approval/decline filters. The service provider will be able to do what-if analysis on the predictive model before accepting/declining it.

In yet other cases, instead of filters, check boxes or scripts might be used to allow a service provider to configure and customize his RSVP functionality. Though most advantageous for small suppliers in this example, in other cases, it may also be used for larger suppliers. For example, rules may be entered allowing a request to be routed to a specific driver of a larger limo company, based on GPS information and availability of those drivers, etc.

In yet another case, the service provider would be able to post to service supplier platform discounted inventory, that the service supplier could through its network offer it to potential users who may be interested in last-minute discounted services. For example a caterer could offer discounted food after a last minute cancellation, or a limo driver could offer a discounted ride to fill an empty return from the airport etc. Using certain rules and filters, certain customers, that for example registered in some cases, could be notified of such a short term opportunity becoming available, similar to co-pending case U.S. patent application Ser. No. 10/869,356, entitled, “SYSTEM AND METHOD FOR AVAILABILITY-BASED LIMITED-TIME OFFERINGS AND TRANSACTIONS,” filed Jun. 15, 2004, incorporated herein by reference.

### Regulating Supplier Acceptance of Service Requests

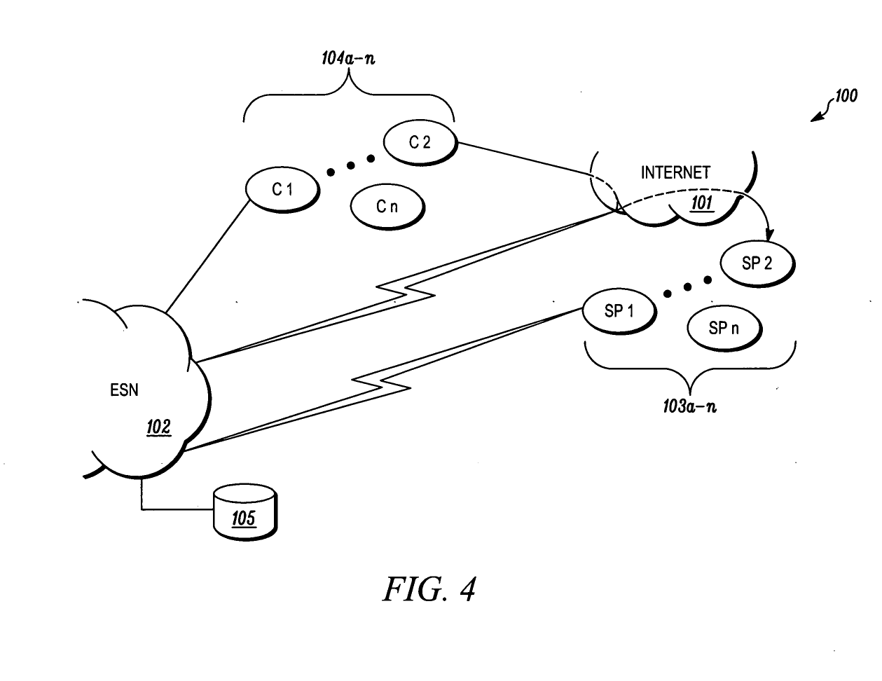

FIG. 4 shows an overview of a system 400 according to the present embodiment. Electronic supplier network (ESN) 402 has a main database 405 and is connected to the Internet 401. Service providers SP1 through SPn 403a-n are connected to ESN 402 either directly or via the Internet or via other, similar networks (e.g., wireless) that are well known in the art. Customers C1 through Cn 404a-n are also connected to ESN 402 in any of similar means, either directly or through the Internet or some other, similar network.

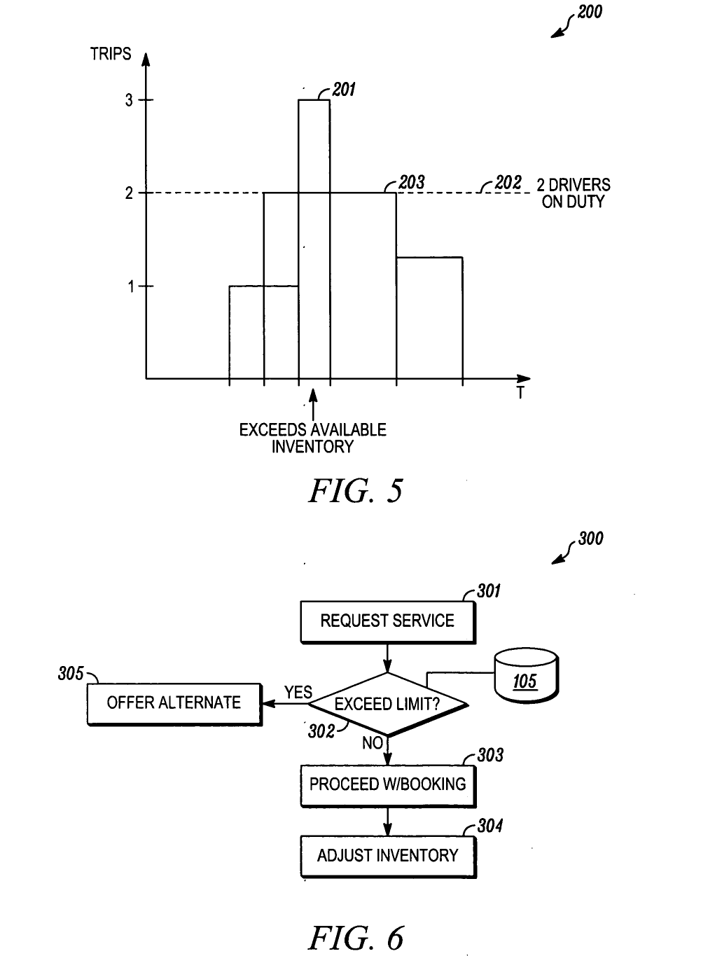

FIG. 5 shows the schematic of an exemplary booking. A given service provider has, for example, two limo drivers. However, as shown in the diagram of capacity requirements and availabilities 500 for said exemplary booking, peak 501 exceeds the maximum capacity 502 of the service because of an overlapping of multiple service requests. This overlap may have at least two consequences: either a ride request simply is not fulfilled, or the start of the next ride 503 is unduly delayed. Based on recognition of this overbooking by the system according to this invention, a customer requesting this service may be offered alternative transportation. In case the supplier's limit is not set correctly in the system (as concluded from a record of complaints, etc.), the system may lower the supplier's limit; in a similar manner, if the supplier receives good reviews, the system may increase the supplier's limit.

For example, in one embodiment, the method of the present invention may lower an identified capacity of the first service provider in response to receiving a number of complaints greater than or equal to a threshold, within a predetermined period of time. In one embodiment, the method of the present invention may raise an identified capacity of the first service provider in response to receiving a number of compliments or positive reviews, greater than or equal to a threshold, within a predetermined period of time. In one embodiment, the method of the present invention may raise an identified capacity of the first service provider in response to receiving a number of complaints less than or equal to a threshold, within a predetermined period of time.

FIG. 6 shows the process flow 600 of a request. At step 601, the system receives a service request. At step 602, the system compares existing bookings of the requested service to the capacity limits of the likely service provider, drawing both sets of data from main database 105. Depending on the results of the comparison, the process branches. If the service request exceeds the capacity limit of the service provider (yes), the system offers an alternative service in step 605, from which, although not shown, the process may restart. If the request does not exceed the capacity limit (no), the process moves to step 603, where the service request is booked. Then is step 604, the system adjusts its records of available inventories and/or capacities (back to database 305).

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

The supplier regulator would include a mechanism that provides real time visibility to the status of suppliers so that we can monitor suppliers that are approaching the limit of their capacity or who may have already exceeded their capacity, or who are experiencing an outage of some kind. It would also maintain a record of historical performance that could be charted. Ideally, this would have some sort of user interface that displays the status of all vendors. It could also generate some type of automated alert as the supplier is reaching their capacity or if they are in a state where they have exceeded or cannot meet their capacity. This could include an email, phone call, text message or other electronic communication.

What is claimed is:

1. A computer implemented method comprising:
In response to receiving a request for a service of a first service
provider, determining if servicing the request will exceed an identified capacity of the first service provider; and
In response to determining servicing the requested service will exceed the identified capacity of the first service provider, offering to a requester of the service an alternative.

2. The computer implemented method of claim 1, wherein the determining includes comparing existing bookings of the requested service to the identified capacity of the first service provider.

3. The computer implemented method of claim 2, wherein the offering to
the requester an alternative service includes offering an alternative second service provider to service the request.

4. The computer implemented method of claim 3, wherein the method is performed by a third service provider, separate from the first service provider.

5. The computer implemented method of claim 4, further comprising lowering an identified capacity of the first service provider in response to receiving a number of complaints greater than or equal to a threshold, within a predetermined period of time.

6. The computer implemented method of claim 4, further comprising raising an identified capacity of the first service provider in response to receiving a number of compliments or positive reviews, greater than or equal to a threshold, within a predetermined period of time.

7. The computer implemented method of claim 4, further comprising raising an identified capacity of the first service provider in response to receiving a number of complaints less than or equal to a threshold, within a predetermined period of time.

8. A machine-readable medium having stored thereon a set of instructions which when executed, perform a method comprising:
In response to receiving a request for a service of a first service provider, determining if servicing the request will exceed an identified capacity of the first service provider; and
In response to determining servicing the requested service will exceed the identified capacity of the first service provider, offering to a requester of the service an alternative.

9. The machine-readable medium of claim 8, wherein the determining includes comparing existing bookings of the requested service to the identified capacity of the first service provider.

10. The machine-readable medium of claim 9, wherein the offering to the requester an alternative service includes offering an alternative second service provider to service the request.

11. The machine-readable medium of claim 10, wherein the method is performed by a third service provider, separate from the first service provider.

12. The machine-readable medium of claim 12, further comprising lowering an identified capacity of the first service provider in response to receiving a number of complaints greater than or equal to a threshold, within a predetermined period of time.

13. The machine-readable medium of claim 12, further comprising raising an identified capacity of the first service provider in response to receiving a number of compliments or positive reviews, greater than or equal to a threshold, within a predetermined period of time.

14. The machine-readable medium of claim 12, further comprising raising an identified capacity of the first service provider in response to receiving a number of complaints less than or equal to a threshold, within a predetermined period of time.

15. A system comprising:
a means for determining if servicing the request will exceed an identified capacity of the first service provider, in response to receiving a request for a service of a first service provider; and
a means for offering to a requester of the service an alternative, in response to determining servicing the requested service will exceed the identified capacity of the first service provider.

16. The system of claim 15, wherein the means for determining includes means for comparing existing bookings of the requested service to the identified capacity of the first service provider.

17. The system of claim 16, wherein the means for offering to the requester an alternative service includes means for offering an alternative second service provider to service the request.

18. The system of claim 17, further comprising means for lowering an identified capacity of the first service provider in response to receiving a number of complaints greater than or equal to a threshold, within a predetermined period of time.

19. The system of claim 17, further comprising means for raising an identified capacity of the first service provider in response to receiving
a number of compliments or positive reviews, greater than or equal to a threshold, within a predetermined period of time.
